(19) United States
(12) Patent Application Publication
(10) Pub. No.: US 2012/0230892 A1
(43) Pub. Date: Sep. 13, 2012

(54) CARRIER WITH FLEXIBLE MICROASSAY DEVICE AND METHODS OF USE

(75) Inventors: Kenneth A. Peterson, White Bear Lake, MN (US); Raymond J. Kenney, Woodbury, MN (US); Kurt J. Halverson, Lake Elmo, MN (US)

(73) Assignee: 3M Innovative Properties Company

(21) Appl. No.: 13/510,164

(22) PCT Filed: Nov. 22, 2010
(86) PCT No.: PCT/US2010/057553

§ 371 Date: May 16, 2012

Related U.S. Application Data
(60) Provisional application No. 61/263,612, filed on Nov. 23, 2009.

(51) Int. Cl. B01L 3/00; B32B 38/10; B32B 37/12

(52) U.S. Cl. 422/552; 156/292; 156/247

(57) ABSTRACT

The disclosure provides a carrier for flexible microassay devices (510). The carrier is detachably attached to the microassay device (510) and provides means for protecting and handling the flexible microassay device (510). A method of preparing a microassay device for use is also disclosed.

### CROSS REFERENCE TO RELATED APPLICATIONS

This application claims the benefit of U.S. Provisional Patent Application No. 61/263,612, filed Nov. 23, 2009, which is incorporated herein by reference in its entirety.

### BACKGROUND

The ability to perform parallel microanalysis on minute quantities of sample is important to the advancement of chemistry, biology, drug discovery and medicine. Today, the traditional 1536-well microtiter plate has been surpassed by microwell arrays which have an even greater number of reaction chambers and use lesser amounts of reagents due to efforts focused on maximizing time and cost efficiencies.

Certain fiber optic bundles have been used to create arrays. Several methods are known in the art for attaching functional groups (and detecting the attached functional groups) to reaction chambers etched in the ends of fiber optic bundles. One disadvantage of this approach is the constraints imposed by the materials comprising the fiber optic bundle. To act as an efficient waveguide, each fiber element must consist of a high refractive index core surrounded by a low refractive index cladding.

Recently, microarrays have been fabricated from moldable, flexible polymeric materials. These arrays can be coupled to a rigid support for optical interrogation. Handling thin, flexible arrays can pose technical challenges that are not evident with the traditional microarrays made from rigid, solid substrates. Moreover, excessive handling of any microarrays, including the traditional microarrays, can create the possibility of contaminating the microarray with materials that may interfere with micro analytical techniques.

Thus, there is a need for articles and methods to prepare thin, flexible microarrays for microanalyses.

### SUMMARY

The present disclosure relates to articles and methods that are used for microanalyses. In particular this disclosure relates to flexible microarrays and the method used to prepare the flexible microarrays for microassays.

The inventive carrier articles can be used to protect flexible microarrays during manufacturing, storage, transport, and use of the microarrays. The articles can provide protection from physical deterioration, chemical contamination and/or biological contamination. Further, the articles can provide an independent structure to facilitate the proper alignment of a microarray when coupling the microarray to a rigid support such as an optical device, for example. Even further; the articles can provide semi-rigid structural support to maintain an even, planar configuration of a microarray when coupling the microarray to a rigid support. The inventive method provides a simple, reliable procedure to prepare a flexible microarray for optical interrogation.

In one aspect, the present disclosure provides an article. The article can comprise a flexible microassay device, a shielding element, and a flexible first protective layer. The flexible microarray can comprise an upper major surface that includes a plurality of microwells and a lower major surface. An adhesive composition can be bonded to at least a portion of the lower major surface. The shielding element can be releasably coupled to the adhesive composition. The shielding element can be dimensioned to be substantially coextensive with the portion of the lower major surface that comprises the adhesive composition. The first protective layer can be releasably coupled to the upper major surface of the microarray.

In any of the above embodiments, the first protective layer can be dimensioned to be substantially coextensive with the microassay device. In any of the above embodiments, the adhesive compound forms an adhesive layer that can be substantially coextensive with the lower major surface of the microassay device.

In any of the above embodiments, the article can further comprise a flexible second protective layer that is releasably coupled to the shielding element and/or the first protective layer. In any of the above embodiments, the second protective layer can be dimensioned to be substantially coextensive with the microassay device.

In any of the above embodiments, the first protective layer can comprise a polymeric film. In any of the above embodiments, the second protective layer can comprise a polymeric film. In any of the above embodiments, the polymeric film can be a translucent or an optically transparent polymeric film.

In any of the above embodiments, the first protective layer can comprise a first body region that is coextensive with the microassay device. The first protective layer further can comprise a first tab region extending from the first body region.

In any of the above embodiments, the second protective layer can comprise a second body region that is coextensive with the microassay device. The second protective layer further can comprise a second tab region extending from the first body region.

In any of the above embodiments, at least a portion of each of the first and second tab regions can overlap. In any of the above embodiments, the article can further comprise a plurality of shielding elements. In any of the above embodiments, at least one of the first and second protective layers can be self-supporting.

In any of the above embodiments, the peel adhesion strength of the coupling between the first protective layer and the upper surface of the microarray article can be greater than the peel adhesion strength of the coupling between the adhesive layer and the shielding element. In this embodiment, the peel adhesion strength of the coupling between the shielding element and the adhesive layer can be less than the peel adhesion strength of the coupling between the shielding element and the second protective layer.

In any of the above embodiments, the microwell article, the body region of the first protective layer, and the body region of the second protective layer each can comprise a peripheral boundary. In this embodiment, the peripheral boundaries of the body regions of the first and second protective layers substantially can extend outside peripheral boundary of the microwell article. In some versions of this embodiment, the peripheral boundaries of the body regions of the first and second protective layers substantially can overlap to form a margin area. In some versions of this embodiment, a portion of the body region of the first protective layer and the body region of the second protective layer can be releasably coupled in the margin area.

In any of the above embodiments, the microarray article can be fabricated from a polymeric resin selected from the group consisting of polyimide, polycarbonate, polystyrene, polypropylene, polyethylene, polybutylene, polyurethane, acrylic-based resins derived from epoxies, polyesters, polyethers, and urethanes, ethylenically unsaturated compounds, aminoplast derivatives having at least one pendant acrylate group, isocyanate derivatives having at least one pendant acrylate group, epoxy resins other than acrylated epoxies, derivatives of the foregoing, and combinations of two or more of the foregoing. In any of the above embodiments, the first protective layer and/or second protective layer can be selected from the group consisting of polyethylene, high density polyethylene, low density polyethylene, linear low density polyethylene, poly(ethylene terephthalate) and Exco Film #29459 heat-sealable packaging film. In any of the above embodiments, the first protective layer can be coupled to the microassay device by a process comprising lamination or heat sealing. In any of the above embodiments, the second protective layer can be coupled to the shielding element by a process comprising lamination or heat sealing.

In another aspect, the present disclosure provides a method of making a carrier device. The method can comprise providing a microassay device and a first protective layer. The microassay device can include upper and lower major surfaces. The upper major surface can comprise a plurality of microwells. At least a portion of the lower major surface can comprise an adhesive composition bonded thereto. A shielding element can be detachably attached to the adhesive composition. The shielding layer can be dimensioned to be substantially coextensive with the portion of the lower major surface that comprises the adhesive composition. The method further can comprise detachably attaching the first protective layer to the upper major surface of the microassay device.

In another aspect, the present disclosure provides a method of making a carrier device. The method can comprise providing a microassay device, a shielding layer, and a first protective layer. The microassay device can include upper and lower major surfaces. The upper major surface can comprise a plurality of microwells. At least a portion of the lower major surface can comprise an adhesive composition bonded thereto. The method further can comprise detachably attaching the shielding element to the adhesive composition such that the shielding element is substantially coextensive with the portion of the lower major surface that comprises the adhesive composition. The method further can comprise detachably attaching the first protective layer to the upper major surface of the microassay device.

In any of the above methods of making a carrier device, the method further can comprise providing a second protective layer and detachably attaching the second protective layer to the shielding element and/or the first protective layer.

In another aspect, the present disclosure provides a method of preparing a microarray for a microanalysis. The method can comprise providing an article and a component of an optical system. The article can include a microassay device with upper and lower major surfaces. The upper major surface can include a plurality of microwells. The upper major surface can be detachably attached to a first protective layer. At least a portion of the lower major surface can include an adhesive composition bonded thereto. Optionally, the article can include a second protective layer attached to the shielding element and/or the first protective layer. The method further can comprise a second protective layer attached to the shielding element and/or the first protective layer. The method further can comprise contacting the lower major surface of the microassay device with the optical system component.

In some embodiments, the method further can comprise removing the first protective layer from the microarray.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a substrate comprising “an” array can be interpreted to mean that the substrate can include “one or more” arrays.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further explained with reference to the drawing figures listed below, where like structure is referenced by like numerals throughout the several views.

FIG. 1 is a top perspective view of an embodiment of a flexible microassay device according to the present disclosure.

FIG. 2a is a cross-sectional side view of one embodiment of a carrier article with a flexible microassay device according to the present disclosure.

FIG. 2b is a top view of the carrier article of FIG. 2a.

FIG. 2c is a cross-sectional side view of another embodiment of a carrier article with a flexible microassay device according to the present disclosure.

FIG. 3 is a cross-sectional side view of another embodiment of a carrier article with a flexible microassay device according to the present disclosure

FIG. 4a is a cross-sectional side view of another embodiment of a carrier article with a flexible microassay device according to the present disclosure.

FIG. 4b is a top view of the carrier article of FIG. 4a.

FIG. 4c is a top view of one embodiment of a carrier article that includes a seal.

FIGS. 5a-5f are side views of one embodiment of steps for preparing a flexible microarray for microanalyses.

### DETAILED DESCRIPTION

The present disclosure provides flexible carrier articles comprising a flexible microassay device. The microassay device comprises micro-scale reaction chambers and further comprises an adhesive composition on at least one major surface. By itself, the flexible microassay device may be sufficiently thin and/or flexible as to be capable of bending to the point at which one portion of the microassay device (e.g., a portion comprising the adhesive composition) can unintentionally contact another portion of the microassay device. The microassay devices can be bonded to elements of the flexible carriers, which then provide a means to protect the microassay device from degradation and/or contamination during storage and/or handling, as well as a means to control the flexion of the microassay device during handling (e.g., preparation for use).

The present disclosure further provides a method of preparing a flexible microassay device for use. The method utilizes the structural features of the carrier article to prevent degradation of the article (e.g., by contamination) and to transfer the article to a surface on which it can be optically interrogated. The method helps guard against undesirable creases, folds, bubbles, and the like, which could potentially be introduced into the microassay device during transfer of the article to an optically-interrogatable surface.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” “containing,” or “having” and variations thereof herein is meant to encompass the items listed thereafter and equivalents thereof as well as additional items. Unless specified or limited otherwise, the terms “supported,” and “coupled” and variations thereof are used broadly and encompass both direct and indirect supports and couplings. It is to be understood that other embodiments may be utilized and structural or logical changes may be made without departing from the scope of the present disclosure. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present disclosure is generally directed to methods and articles for delivery of thin film microarrays to a rigid substrate.

Definitions:

Unless otherwise defined, all technical and scientific terms used herein have the same meaning as commonly understood by one of ordinary skill in the art to which this invention belongs. Methods and materials similar or equivalent to those described herein can be used in the practice of the present invention, and exemplified suitable methods and materials are described below. For example, methods may be described which comprise more than two steps. In such methods, not all steps may be required to achieve a defined goal and the invention envisions the use of isolated steps to achieve these discrete goals. The disclosures of all publications, patent applications, patents and other references are incorporated herein by reference in their entirety. In addition, the materials, methods, and examples are illustrative only and not intended to be limiting.

“Analyte” means a molecule, compound, composition or complex, either naturally occurring or synthesized, to be detected or measured in or separated from a sample of interest. Analytes include, without limitation, polypeptides (e.g., proteins), peptides, amino acids, fatty acids, polynucleotides (including, but not limited to DNA, RNA, cDNA, mRNA, PNA, LNA), carbohydrates, hormones, steroids, compounds, lipids, vitamins, bacteria, viruses, pharmaceuticals, ATP, and metabolites. An analyte may be one member of a ligand/anti-ligand pair or one member of a pair of polynucleotides having sufficient complementarity to participate in a hybridization event.

“Fiber optic faceplate” refers to a bundle of fiber optic cables which are fused together to form a monolithic structure which is then “sliced” and polished to form a “wafer” of required thickness.

“Optically transparent” refers to the ability of light to transmit through a material. “Optically isolated”, as used herein, refers to a condition whether by light that is directed into a microwell in an article or that is emitted by a component or a reaction contained in a microwell, is not substantially transmitted laterally through the article and detectably associated with a proximate microwell (i.e., less than 20% of the light; preferably, less than 10% of the light; more preferably, less than 5% of the light; even more preferably, less than 1% of the light is transmitted and detectably associated with a proximate microwell).

“Reaction Chamber” means a localized well or chamber (i.e. a hollowed-out space, having width and depth) on a substrate, comprising side walls and a bottom that is used to facilitate the interaction of reactants.

“Thin film” refers to the coating of material deposited on the surface of the substrate less than 1.0 microns thick.

A “microwell array” is an array of regions having a density of discrete regions of at least about 100/cm², and preferably at least about 1000/cm². The regions in a microwell array have typical dimensions, e.g., diameters, in the range of between about 10-250 μm, and are separated from other regions in the array by about the same center to center distance. By “array” herein is meant a plurality of reaction chambers, which are localized wells or chambers in an array format on the substrate material; the size of the array and its reaction chambers will depend on the composition and end use of the array.

Microassay Device Carrier Articles

Flexible, molded microassay devices have been developed as a low-cost alternative to arrays that are produced by etching microcavities in rigid substrates such as glass slides or fiber optic discs, for example. Processes for producing flexible, molded microassay devices are described, for example, in PCT International Publication Nos. WO 2003/016868; WO 2005/039769; and U.S. Patent Application No. 61/263,640, filed Nov. 23, 2009 and entitled “MICROWELL ARRAY ARTICLES AND METHODS OF USE”; each of which is incorporated herein by reference in its entirety.

In some embodiments, microwell assay devices can have a total thickness of about 20 microns to about 75 microns. In some embodiments, the microwell arrays can have a total thickness of about 25-50 microns.

The inventors have discovered that it is advantageous to provide a flexible structure (e.g., a carrier) to support a thin film microassay device when handling the microassay device and, in particular, when transferring the thin film microassay device to the surface of an optical device. Even more advantageously, the flexible support structure is less flexible than the flexible microassay device. Even more advantageously, the inventors have discovered that a layer applied to one of the major surfaces of a thin-film microassay device can serve the dual purpose of protecting the microassay device during manufacturing, storage, transport, and use of the microassay device as well as providing structural support when handling the microassay device.

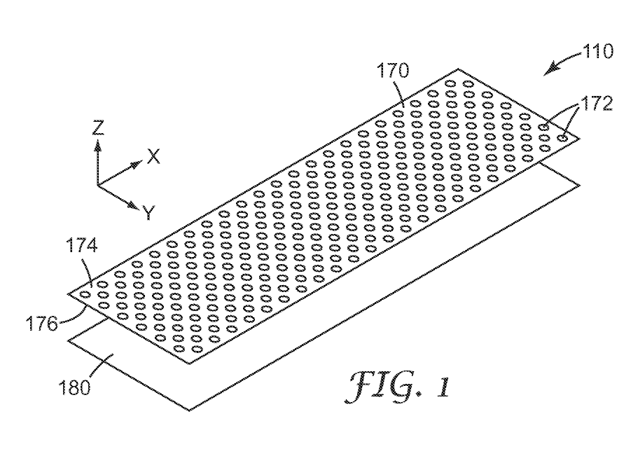

FIG. 1 shows a top perspective view of a flexible microassay device 110 with upper and lower major surfaces 174 and 176, respectively. The upper major surface includes a plurality of microwells 172, which can serve as reaction chambers in a microanalytical assay. The device 110 further comprises an optically-transmissive flexible layer 180 coupled to the lower major surface 176 of the device 110. FIG. 1 further shows a set of axes to illustrate that, preferably, the microwells 172 are optically isolated such that light is not substantially transmitted within the plane formed by the X-Y axes. However, light can be substantially transmitted from the microwells 172 in a direction that is predominantly oriented toward the Z axis or, preferably, substantially parallel with the Z axis.

The microassay device 110 can be any unitary microassay device fabricated from flexible polymeric materials. Nonlimiting examples of suitable polymeric materials include polyimide, polycarbonate, polystyrene, polypropylene, polyethylene, polybutylene, polyurethane, acrylic-based resins derived from epoxies, polyesters, polyethers, and urethanes, ethylenically unsaturated compounds, aminoplast derivatives having at least one pendant acrylate group, isocyanate derivatives having at least one pendant acrylate group, epoxy resins other than acrylated epoxies, derivatives of the foregoing, and combinations of two or more of the foregoing. The term acrylate is used here to encompass both acrylates and methacrylates. Suitable polymeric materials include copolymers.

Ethylenically unsaturated resins include both monomeric and polymeric compounds that contain atoms of carbon, hydrogen and oxygen, and optionally nitrogen, sulfur, and halogens may be used herein. Oxygen or nitrogen atoms, or both, are generally present in ether, ester, urethane, amide, and urea groups. Ethylenically unsaturated compounds preferably have a molecular weight of less than about 4,000 and preferably are esters made from the reaction of compounds films containing aliphatic monohydroxy groups, aliphatic polyhydroxy groups, and unsaturated carboxylic acids, such as acrylic acid, methacrylic acid, itaconic acid, crotonic acid, iso-crotonic acid, maleic acid, and the like. Such materials are typically readily available commercially and can be readily cross linked.

The microassay devices are adapted for performing microchemical reactions, such as biochemical reactions (e.g., binding assays, antigen-antibody binding reactions, receptor ligand binding reactions, enzyme assays, nucleic acid hybridization reactions, nucleic acid sequencing reactions), for example. In some embodiments, the microassay devices comprise microvolume reaction chambers (e.g., microcavities or microwells). In some embodiments, the microassay devices are substantially planar and comprise loci (e.g., surface-modified sites) at which molecules can be attached and can participate in binding reactions and/or catalytic reactions.

The flexible microassay devices can be made by processes such as contacting a template with a moldable material. Non-limiting examples of such processes are described, for example, in PCT International Publication Nos. WO 2003/016868 and WO 2005/039769 and U.S. Patent Application No. 61/263,640, filed Nov. 23, 2009.

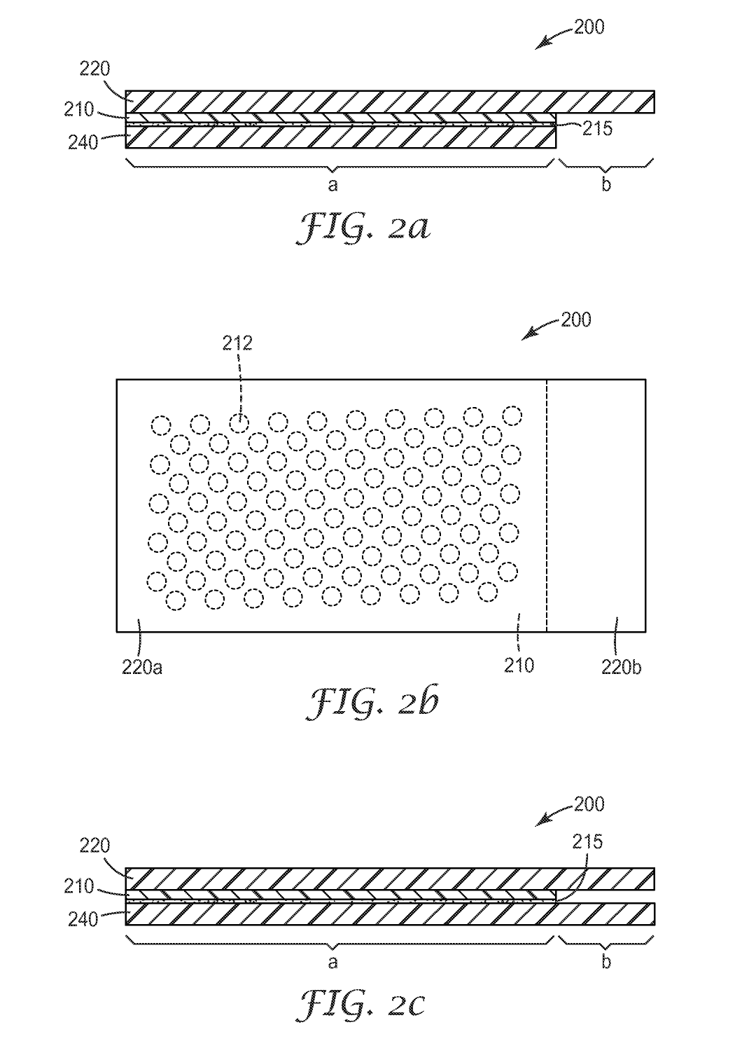

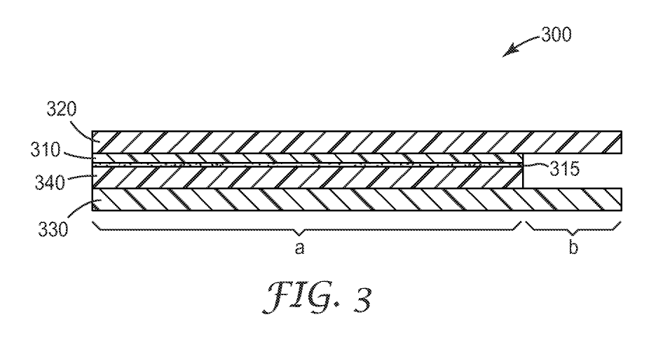

FIG. 2a shows a side view of one embodiment of an article according to the present disclosure. The article 200 comprises a flexible microassay device 210 that includes an adhesive composition 215 on its lower major surface. A first protective layer 220 is coupled to the microassay device 210 on the upper major surface (the surface comprising the microwells) of the microassay device 210. Preferably, the first protective layer 220 is coextensive with at least the portion of the microassay device that comprises microwells (see FIG. 1, which illustrates that the microassay device may comprise a portion (e.g., a tab region) that does not comprise microwells). In the illustrated embodiment, the first protective layer 220 is coextensive with the entire upper major surface of the microassay device 210.

The adhesive composition 215 is shown as a continuous layer coated along the length of the lower major surface of the microassay device 210. In other embodiments (not shown), the adhesive composition may be applied to only a portion (e.g., the portion proximate one or more edges of the device 210, the portion proximate the perimeter or the device, a central portion of the device, and combinations of portions thereof) of the lower major surface of the microassay device 210. A shielding element 240 is detachably coupled to the adhesive composition 215. The shielding element 240, until detached from the microassay device 210, serves to prevent the adhesive composition 215 from unintentionally coupling the microassay device 210 to itself or to another object.

FIG. 2a shows the body region (“a”), which is substantially coextensive with the microassay device 210, of the first protective layer 220. Extending beyond an edge of the microassay device 210 is the tab region (“b”) of the first protective layer 220.

The adhesive layer comprises any suitable adhesive (e.g., a pressure-sensitive adhesive, such as capable of bonding to the moldable material from which the microassay device is made and to a component of an optical system. In certain preferred embodiments, the adhesive layer is substantially transparent. In some embodiments, the adhesive layer is substantially nonfluorescent.

FIG. 2b shows a top view of the article of FIG. 2a. FIG. 2b illustrates that the first protective layer body 220a of the article 200 is substantially coextensive with the microassay device 210, thereby forming a covering over the microwells 212. In some embodiments, the first protective layer is coextensive with the microassay device 210 and the device 210 can be fabricated, for example, by forming a laminate comprising the microassay device 210 and the first protective layer 220 and, subsequently, die-cutting the laminate. The first protective layer tab region 220b extends from a portion of the first protective layer body 220a. Although shown as a rectangular shape in FIG. 2b, the microassay device 210 and corresponding article 200 of this and other embodiments can be any shape, including a circle, an oval, a triangle, a square, a pentagon, for example, or an irregular shape. Although the first protective layer body region 220a and first protective layer tab region 220b are shown as portions of a unitary first protective layer in FIG. 2a, it is anticipated that, in some embodiments, a separate tab element could be coupled to a first protective layer (not shown).

FIG. 2c shows a side view of another embodiment of an article according to the present disclosure. The article 200 comprises a flexible microassay device 210 that includes an adhesive composition 215 on its lower major surface. A first protective layer 220 is coupled to the microassay device 210 on the upper major surface (the surface comprising the microwells) of the microassay device 210. Preferably, the first protective layer 220 is coextensive with at least the portion of the microassay device that comprises microwells (see FIG. 1, which illustrates that the microassay device may comprise a portion (e.g., a tab region) that does not comprise microwells). In the illustrated embodiment, the first protective layer 220 is coextensive with the entire upper major surface of the microassay device 210.

The adhesive composition 215 is shown as a continuous layer coated along the length of the lower major surface of the microassay device 210. In other embodiments (not shown), the adhesive composition may be applied to only a portion (e.g., the portion proximate one or more edges of the device 210, the portion proximate the perimeter or the device, a central portion of the device, and combinations of portions thereof) of the lower major surface of the microassay device 210. A shielding element 240 is detachably coupled to the adhesive composition 215. The shielding element 240, until detached from the microassay device 210, serves to prevent the adhesive composition 215 from unintentionally coupling the microassay device 210 to itself or to another object.

FIG. 2c shows the body region (“a”), which is substantially coextensive with the microassay device 210, of the first protective layer 220. Extending beyond an edge of the microassay device 210 is the tab region (“b”) of the first protective layer 220 and the shielding element 240, respectively.

The adhesive layer comprises any suitable adhesive (e.g., a pressure-sensitive adhesive, such as capable of bonding to the moldable material from which the microassay device is made and to a component of an optical system. In certain preferred embodiments, the adhesive layer is substantially transparent. In some embodiments, the adhesive layer is substantially nonfluorescent.

FIG. 3 shows a side view of one embodiment of an article according to the present disclosure. The article 300 comprises a flexible microassay device 310 that includes an adhesive composition 315 on its lower major surface. A first protective layer 320 is coupled to the microassay device 310 on the upper major surface (the surface comprising the microwells) of the microassay device 310. Preferably, the first protective layer 320 is coextensive with at least the portion of the microassay device that comprises microwells. In the illustrated embodiment, the first protective layer 320 is coextensive with the entire upper major surface of the microassay device 310. A second protective layer 330 is coupled to the shielding element 340. FIG. 3 shows the body region (“a”), which is substantially coextensive with the microassay device 310, of the first and second protective layers (320 and 330, respectively). Extending beyond an edge of the microassay device 310 is the tab region (“b”) of the first and second protective layers (320 and 330, respectively).

The first and second protective layers can be formed from a variety of suitable materials. The materials, preferably, are flexible enough to permit roll-to-roll processing when fabricating the articles, yet relatively more rigid than the flexible microassay device. Suitable materials include paper, plastic films, metal foils, and combinations thereof. In some embodiments, the first and second protective layers are fabricated from the same material. In some embodiments, the first and second protective layers are fabricated from different materials.

In certain preferred embodiments, at least one protective layer; preferably, at least the first protective layer; is optically transparent or translucent enough to permit visualization of the microassay device through the protective layer. In some embodiments, the first and second protective layers are fabricated from a plastic film, such as high density polyethylene (HDPE) film, for example. An example of a suitable HDPE film is part number CD-103 Clear HDPE, available from Charter Films, Superior, Wis.

The first protective layer is fabricated such that it can be bonded to the upper major surface of a microassay device. In some embodiments, the first protective layer may comprise an adhesive to form a bond with the microassay device. Suitable adhesives for the first protective layer include pressure-sensitive adhesives such as acrylics or polyurethane based pressure sensitive adhesives, for example, and heat-sealable materials such as ethylene-vinyl acetate copolymers, for example. The adhesive should be selected such that it provides a detachable bond between the first protective layer and the microassay device, the adhesive bond is readily broken without adversely affecting the structure or performance of the microassay device, the adhesive does not adversely affect one or more components of a microassay in the microassay device, or the adhesive does not substantially interfere with the optical detection of a microassay in the microassay device.

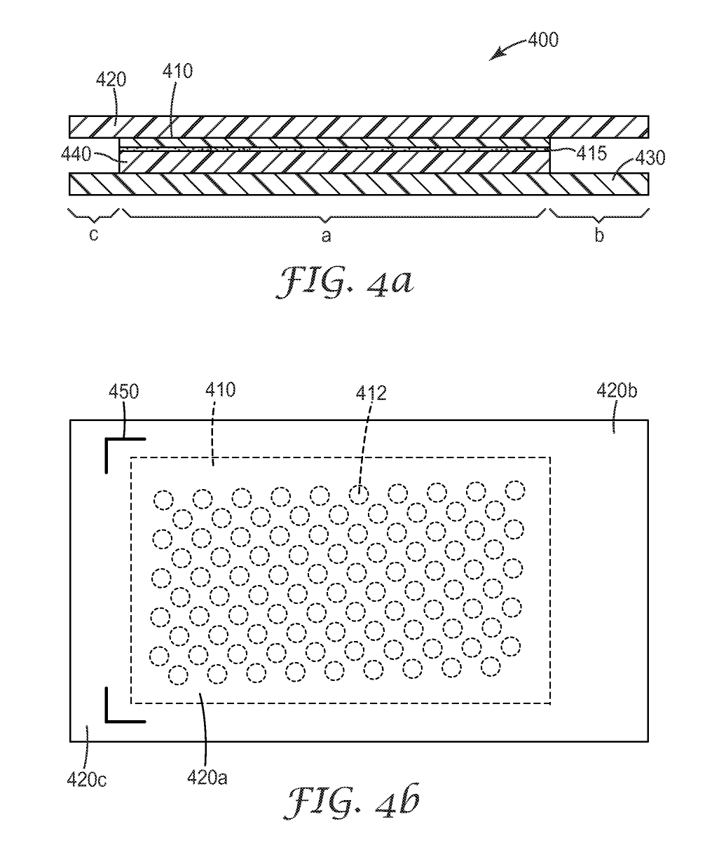

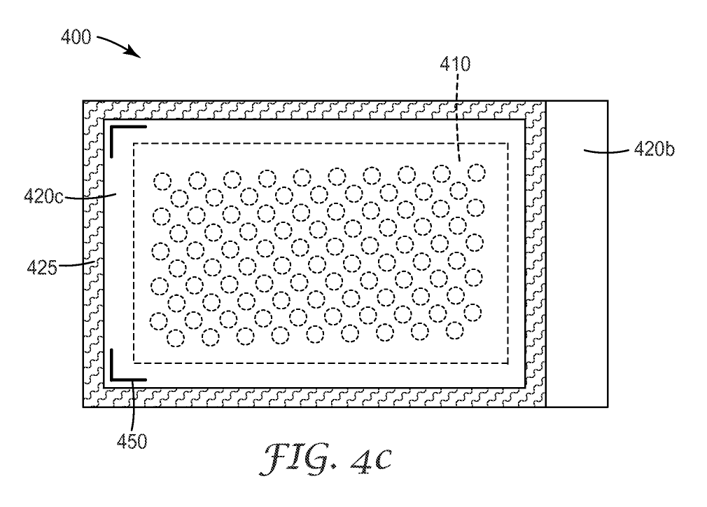

FIG. 4a shows another embodiment of an article according to the present disclosure. The article 400 comprises a flexible microassay device 410 that includes an adhesive layer 415. A first protective layer 420 is coupled to the microassay device 410 on the major surface opposite the adhesive layer 415. A shielding element 440 is coupled to the adhesive layer 415. A second protective layer 430 is coupled to the shielding element 440. FIG. 4a shows the body region (“a”), which is substantially coextensive with the microassay device 410, of the first and second protective layers (420 and 430, respectively). Extending beyond one edge of the microassay device 410 is the tab region (“b”) of the first and second protective layers (420 and 430, respectively). Extending beyond another edge of the microassay device 410 is a margin area (“c”). The margin area “c”, is a portion of the article outside of the tab region where the peripheral boundaries of the first and second protective layers overlap and extend beyond the peripheral boundary of the microassay device.

FIG. 4b shows a top view of the article of FIG. 4a. FIG. 4b illustrates that the first protective layer body 420a of the article 400 is substantially coextensive with the microassay device 410, thereby forming a covering over the microwells 412. The first protective layer tab region 420b extends from a portion of the first protective layer body 420a. Like the tab region 420b, the first protective layer margin area 420c extends from the first protective layer body 420a beyond the peripheral boundary of the microassay device 410. Also shown in FIG. 4b are alignment indicia 450. Alignment indicia can be any marking or combination of markings (e.g., lines, dots, lettering, symbols, or the like) that can serve as a point of reference to properly align the microassay device 410 with a component of an optical system (e.g., a camera, a fiber optic array, a line scanner (not shown)).

Components of an optical system include a number of materials and/or devices that permit the interrogation of a plurality of assay sites in the microassay device. Nonlimiting examples of components include a camera lens; a fiber optic array; a light-transmissive carrier (e.g., a glass slide, an optical filter, a polymeric sheet) to support the microassay device in an optical system; an opaque carrier (e.g., any material that is substantially non-transmissive to light) to support the microassay device in an optical system; and a reflective carrier (e.g., a glass substrate, a metal substrate, a metal film, a polymeric films) to support the microassay device in an optical system. The component of the optical system should be substantially planar and should not substantially deteriorate the adhesive layer, the microassay device, the reaction that is carried out in the microassay device, or the optical signal used to detect the reaction.

FIG. 4c shows a top view of another embodiment of an article according to the present disclosure. In this embodiment, the first protective layer margin areas 420c and tab region 420b of the article 400 comprise a seal 425. The seal 425 bonds the first and second protective layers together, forming a protective barrier surrounding the microassay device 410 and thereby inhibiting the spontaneous separation of one or more of the protective layers from the microassay device. The seal 425 also functions to prevent contaminants from entering the article 400. The seal 425 can be formed using a variety of means known in the art (e.g., ultrasonic welding, any thermal bonding technique (e.g., heat and/or pressure applied to melt a portion of the first and/or second protective layers), adhesive bonding, stapling, and stitching). Preferably, the seal is formed with the adhesive of the packaging web itself.

An exemplary process for manufacturing an article according to the present disclosure includes the following steps:

A flexible microassay device comprising upper and lower major surfaces is provided. The upper major surface of the microassay device comprises a plurality of microwells. In some embodiments, the microassay device may comprise an adhesive composition bonded to at least a portion of its lower major surface. In some embodiments, the adhesive composition may be a uniform layer on the lower major surface of the microassay device. In some embodiments, the flexible microassay device may further comprise a shielding element (e.g., a release liner) detachably attached to the adhesive composition such that the shielding layer is substantially coextensive with the portion of the lower major surface that comprises the adhesive composition.

An adhesive composition, if not already present, is applied to at least a portion of the lower major surface (opposite the microwells or assay sites) of the flexible microassay device. In some embodiments, the adhesive layer can be coated onto the microassay device using coating processes that are known in the art. In some embodiments, the adhesive layer can be disposed on a liner, which is laminated to the microassay device using lamination processes that are known in the art. In some embodiments, liner remains with the article as the shielding element. Alternatively, a shielding element is laminated to the adhesive layer.

A first protective layer (e.g., 2.6 mil HDPE) is coupled to the upper major surface of the flexible microassay device. The first protective layer may comprise an adhesive coating, such as WD-4007 adhesive, available from HB Fuller (Vadnais Heights, Minn.), for example. The first protective layer can be adhesively bonded to the microassay device using a lamination process. The area of the first protective layer can extend beyond a portion of the peripheral boundary of the microassay device to form a tab region. Optionally, the area of the first protective layer may extend beyond the entire peripheral boundary of the microassay device, thereby also forming a margin area around the microassay device.

Optionally, a second protective layer (e.g., 2.6 mil HDPE) is coupled to the shielding element and/or the first protective layer. The second protective layer may comprise an adhesive coating, such as WD-4008 adhesive, available from HB Fuller (Vadnais Heights, Minn.), for example. The second protective layer can be adhesively bonded to the shielding element and/or the first protective layer using a lamination process. The area of the second protective layer can extend beyond a portion of the peripheral boundary of the microassay device to form a tab region. At least a portion of the tab region of the second protective layer may overlap at least a portion of a tab region of the first protective layer. Optionally, the area of the second protective layer may extend beyond the entire peripheral boundary of the microassay device, thereby also forming a margin area around the microassay device. A portion or all of the margin area of the second protective layer may overlap a portion or all of the margin area of the first protective layer. In some embodiments, a seal may be formed in the margin area, as described above.

Method of Preparing a Flexible Microassay device for Microanalysis

The present disclosure provides a method to prepare a flexible microassay device for microanalysis. The method comprises providing an article that includes 1) a microassay device with upper and lower major surfaces, wherein the upper major surface includes a plurality of microwells, wherein the upper major surface is detachably attached to a first protective layer, wherein at least a portion of the lower major surface includes an adhesive composition bonded thereto; 2) a shielding element detachably attached to the adhesive composition such that the shielding element is substantially coextensive with the portion of the lower major surface that comprises the adhesive composition; and 3) optionally, a second protective layer attached to the shielding element and/or the first protective layer. The method further comprises providing a component of an optical system. The method further comprises separating the shielding element from the microassay device. The method further comprises contacting the lower major surface of the microassay device with the optical system component.

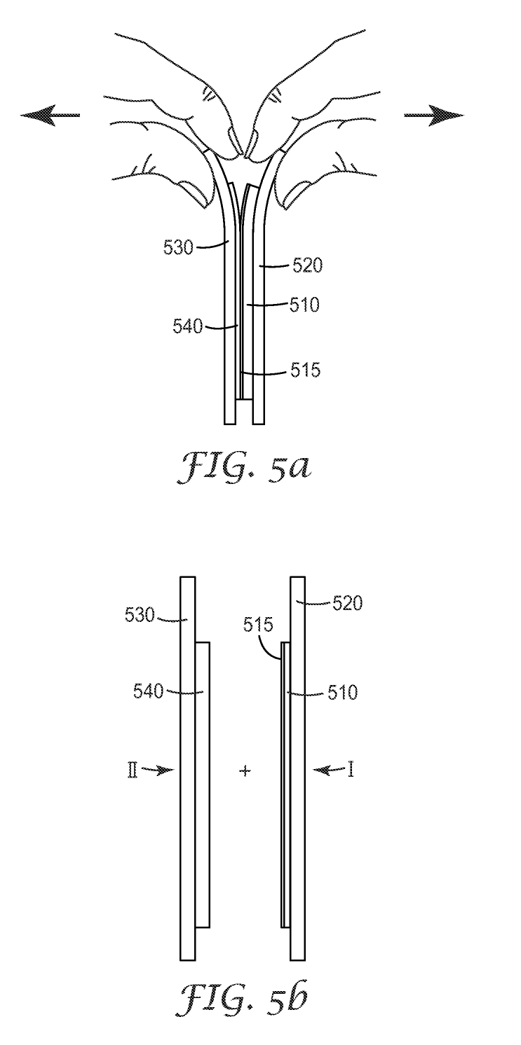

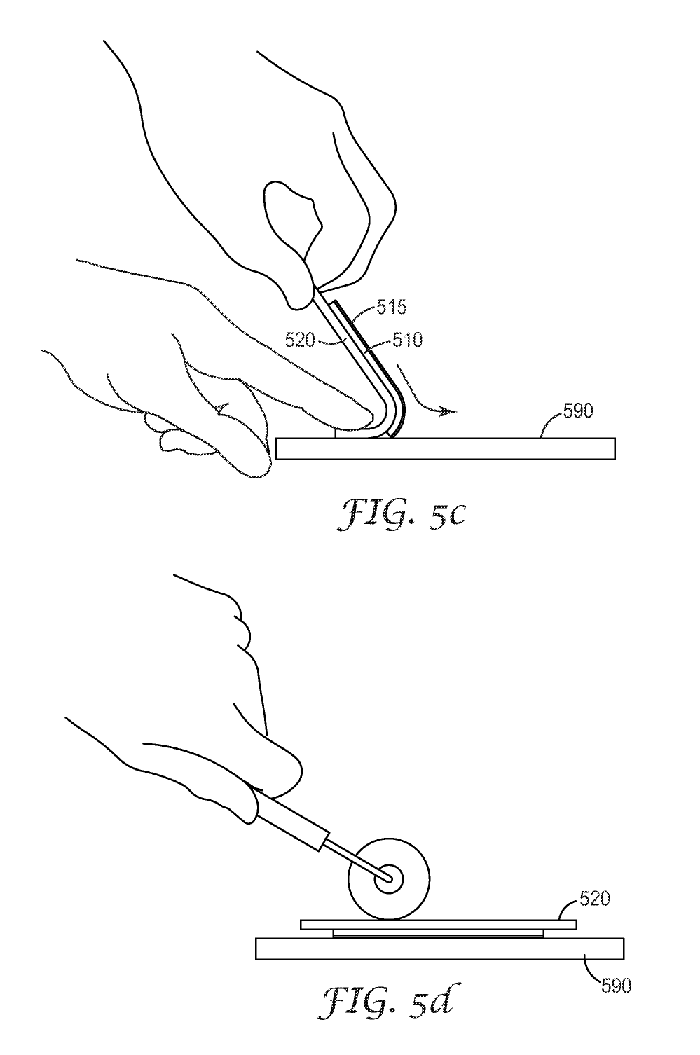

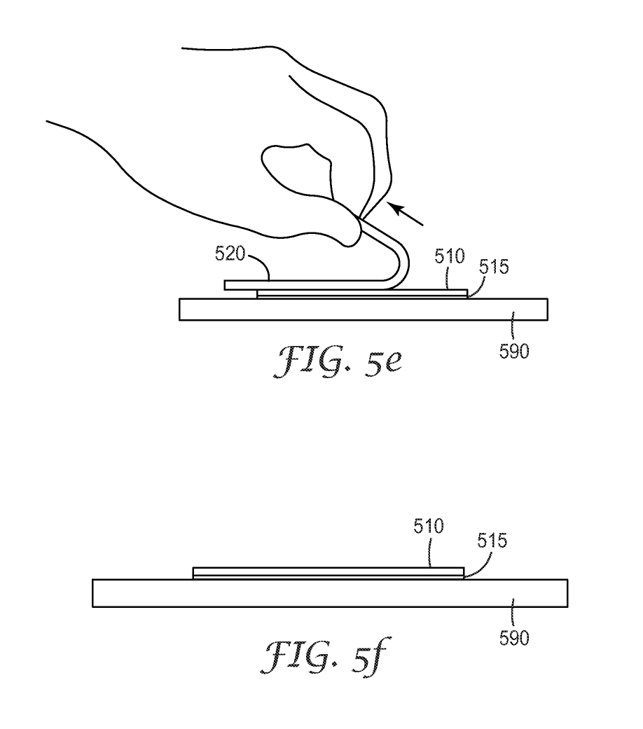

FIGS. 5a-5f illustrate one embodiment of the method to prepare a flexible microassay device for microanalysis. FIG. 5a shows an article 500 comprising a flexible microassay device 510 according to the article of FIG. 4a. The microassay device 510 comprises an adhesive composition (adhesive layer 515). The article further comprises a shielding element 540 releasably bonded to the adhesive layer 515, a first protective layer 520 releasably bonded to the microassay device 510, and an optional second protective layer 530 releasably bonded to the shielding element 540. In this embodiment, the first protective layer tab region 520b and second protective layer tab region 530b are separated by grasping and pulling the tab regions of the protective layers in opposing directions, as indicated by the arrows.

FIG. 5b shows the two components (I and II) resulting from the separation of the protective layers during the step described in FIG. 5a. In this embodiment, component I comprises the first protective layer 520 with the microassay device 510 comprising an adhesive layer 515 bonded thereto. Component II comprises the second protective layer 530 with the shielding layer 540 bonded thereto. Thus, in this embodiment, the peel adhesion strength of the bond between the first protective layer 520 and the microassay device 510, the peel adhesion strength of the bond between the microassay device 510 and the adhesive layer 515, and the peel adhesion strength of the bond between the second protective layer 530 and the shielding element 540 are all greater than the peel adhesion strength of the bond between the shielding element 540 and the adhesive layer 515. In an alternative embodiment (not shown), the relative peel adhesion strengths can be selected such that when the first and second protective layers are separated, the shielding element remains bonded to the adhesive layer rather than the second protective layer. In that embodiment, the shielding element could be separated from the adhesive layer in another step, prior to contacting the microassay device to the optical component.

Component I, comprising the microassay device 510, is then contacted with a component 590 of an optical system, as shown in FIG. 5c. In a preferred embodiment, a peripheral portion (e.g., an edge) of the adhesive layer 515 of the microassay device 510 is contacted with the optical component 590 (e.g., a camera, a fiber optic face plate). The remainder of the adhesive layer 515 is contacted with the component 590, preferably, by bending the component I into a slightly curved shape and “rolling” the adhesive layer 515 of the curved flexible microassay device 510 in the direction of the arrow onto the component 590 in a smooth motion to avoid the formation of wrinkles and/or the entrainment of air bubbles between the adhesive layer 515 and the microassay device 510.

After contacting the microassay device 510 with the optical component 590, the microassay device 510 can be processed to achieve a substantially uniform, flat surface on the optical component 590. FIG. 5d shows how, optionally, a roller 595 can be contacted to the exposed surface of the first protective layer 520 to provide uniform contact between the microassay device 510 and the optical component 590. This process can further provide more uniform optical properties (e.g., depth of field, depth of focus, adhesive thickness) for imaging each reaction site in the microassay device 510.

The first protective layer 520 is removed from the microassay device 510 to expose the reactive sites for microanalyses, as shown in FIG. 5e. Optionally, a roller may be contacted to the surface of the microassay device 510, as described above. FIG. 5f shows the microassay device 510 optically coupled via adhesive layer 515 to the optical component 590 for microanalyses.

It should be noted that the process shown in FIGS. 5a-5f could also be performed using the article 400 shown and described in FIG. 4c.

The invention will be further illustrated by reference to the following non-limiting Examples. All parts and percentages are expressed as parts by weight unless otherwise indicated.

### EXAMPLES

All parts, percentages, ratios, etc. in the examples are by weight, unless noted otherwise. Solvents and other reagents used were obtained from Sigma-Aldrich Chemical Company; Milwaukee, Wis. unless specified differently.

Materials

3 M 8402: a tape obtained from 3 M Company, St. Paul, Minn.

3 M 8403: a tape obtained from 3 M Company, St. Paul, Minn.

Carbon black paste #9B898: 25 % carbon black paste obtained from Penn Color, Doylestown, Pa.

CD-103: A high density polyethylene (HDPE) film obtained from Charter Films, Superior, Wis.

Darocur 1173: 2-hydroxy-2-methylprophenone obtained from Ciba Specialty Chemicals, Basel, Switzerland.

Darocur TPO: diphenyl (2,4,6 -trimethylbenzoyl) phosphine oxide obtained from Ciba Specialty Chemicals, Basel, Switzerland.

Desmodur W: a diisocyanate, sometimes referred to as H12MDI or HMDI, obtained from Bayer, Pittsburgh, Pa.

Dytek A: an organic diamine obtained from Invista, Wilmington, Del.

EGC-1720: a fluorocarbon solution obtained from 3M Company, St. Paul, Minn.

Exco Film #29459: A two layer film of PET and ethylene vinyl acetate obtained from 3M Company, St. Paul, Minn.

Fluorescebrite Plain Microspheres: Fluorescent beads obtained from Polysciences, Inc. Warrington Pa.

Irgacure 819: phenyl-bis-(2,4,6 -trimethyl benzoyl) phosphine oxide obtained from Ciba Specialty Chemicals, Basel, Switzerland.

Kapton H: a polyimide film obtained from DuPont, Wilmington, Del.

Leucophor BCR: a fluorescent dye obtained from Clariant, Charlotte, N.C.

Loparex 10256: a fluorosilicone treated PET release liner obtained from Loparex, Willowbrook, Ill.

Melinex 453: a 25 micron (1 mil) thick polyester film, which is adhesion treated on one side, obtained from Dupont, Wilmington, Del.

Photomer 6210: obtained from Cognis, Monheim, Germany

Photomer 6602: obtained from Cognis, Monheim, Germany

Scotchcast Electrical Resin #5: a resin obtained from 3M Company, St. Paul, Minn.

SilFlu 50MD07: A release liner available from SilicoNature USA, LLC, Chicago, Ill.

SR238: 1,6 hexanediol diacrylate obtained from Sartomer, Inc., Exton Pa.

SR339: 2 -phenoxy ethyl acrylate obtained from Sartomer, Inc., Exton Pa.

SR545: an MQ resin obtained from Momentive Performance Materials, Albany, N.Y.

Teonex Q71: a six micron thick poly(ethylene naphthalate), or PEN, film obtained from Dupont-Teijin, Chester, Va.

78#/3,000 ft² paper carrier (402-7802 ): a paper carrier obtained from Wausau-Mosinee Paper Company, Rhinelander, Wis.

Scotchpak 9733: a heat sealable polyester obtained from 3M Company, St. Paul, Minn.

Vitel 1200B: a copolyester resin obtained from Bostik, Wauwatosa, Wis.

Violet 9S949D: a violet paste containing 20% pigment solids obtained from Penn Color, Doylestown, Pa.

WD-4007: an adhesive obtained from H. B. Fuller, Vadnais Heights, Minn.

WD-4008: an adhesive obtained from H. B. Fuller, Vadnais Heights, Minn.

Microreplication Tooling

Tooling was prepared by a laser ablation process according to the procedure discussed in U.S. Pat. No. 6,285,001, which is incorporated herein by reference in its entirety. Tool A was constructed by coating a urethane acrylate polymer (Photomer 6602) to an approximately uniform thickness of 165 microns onto an aluminum backing sheet as described in Unites States Patent Application Publication No. 2007/0231541, which is incorporated herein by reference in its entirety, followed by ablating the coating to produce a hexagonally packed array of posts. The resulting posts had a center to center distance of 42 microns. Each post comprised a circular top having a diameter of 27 microns, a sidewall angle of approximately 10 degrees, and a height of 39 microns. Tool B was constructed by ablating a 125 micron thick Kapton H polyimide film to construct posts having a hexagonally packed array of posts. The resulting posts had a center to center distance of 34 microns and each post comprised a circular top having a diameter of 27 microns, a sidewall angle of approximately 10 degrees, and a height of 34 microns. Tool C was constructed from Photomer 6602 in the same way as Tool A to make a hexagonally packed array of posts with center to center distance of 34 microns. Each post comprised a circular top having a diameter of 27 microns, a sidewall angle of approximately 10 degrees, and a height of 34 microns.

Tooling Surface Treatments

The polymer Tool A was first plasma treated using an apparatus described in detail in U.S. Pat. No. 5,888,594, which is incorporated herein by reference in its entirety. The polymer tool was mounted onto the cylindrical drum electrode and the chamber was pumped down to a base pressure of 5×10⁻⁴ Torr. Argon gas was introduced into the chamber at a flow rate of 500 sccm (standard cubic centimeters per minute) and plasma ignited and maintained at a power of 500 watts for 30 seconds. After the argon plasma treatment, tetramethylsilane vapor was introduced into the chamber at a flow rate of 360 sccm and the plasma sustained at a power of 500 watts for 30 seconds. After the plasma treatment in tetramethylsilane vapor, oxygen gas was introduced into the chamber at a flow rate of 500 sccm and plasma sustained at a power of 500 watts for 60 seconds. The pressure in the chamber during these plasma treatment steps was in the 5-10 mTorr range. The plasma chamber was then vented to atmosphere and the treated tool was dipped in EGC-1720 fluorocarbon solution. The treated tool was heated in an oven at 120 C for 15 minutes. Tool C was treated in the same way as Tool A.

The polymer Tool B was plasma treated using an apparatus described in detail in U.S. Pat. No. 5,888,594, which is incorporated herein by reference in its entirety. The polymer tool was mounted onto the cylindrical drum electrode and the chamber was pumped down to a base pressure of 5×10⁻⁴ Torr. Argon gas was introduced into the chamber at a flow rate of 500 sccm and plasma ignited and maintained at a power of 500 watts for 30 seconds. After the argon plasma treatment, tetramethylsilane vapor was introduced into the chamber at a flow rate of 360 sccm and the plasma sustained at a power of 500 watts for 30 seconds.

Resin Preparation

Resin formulations were prepared as follows.

Solution A: 1125 grams of Photomer 6210, 375 grams of SR238 and 15 grams of Darocur 1173 were combined in a glass jar. Solution B: 3.75 g of Irgacure 819 was added to SR 339 followed by roller mixing overnight to dissolve the Irgacure 819. Solution C: 3.75 grams of Irgacure 819 was added to 187.5 grams of SR 238 followed by roller mixing 18 hours to dissolve the Irgacure 819. Solution D: solutions A, B, and C were combined in a glass jar followed by mixing. To this was added Darocur 1173 (3.7 g) and Darocur TPO (32 g) followed by roller mixing for 30 minutes.

Solution E: Solution D (708 g) was placed in an amber glass jar. Carbon black paste #9B898 (97 g) was added to the solution and roller mixed for 18 hours to provide a resin formulation with a final carbon black concentration of 3%.

Solution F: Solution D (466 g) was placed in an amber glass jar. Carbon black paste #9B898 (40.5 g) was added to the solution and roller mixed for 18 hours to provide a resin formulation with a final carbon black concentration of 2%.

Solution G: Solution D (466 g) was placed in an amber glass jar. Carbon black paste #9B898 (19.4 g) was added to the solution and roller mixed for 18 hours to provide a resin formulation with a final carbon black concentration of 1%.

Solution H: Solution D (708 g) was placed in an amber glass jar. Violet 9S949D (121 g) was added to the solution and roller mixed for 18 hours to provide a resin formulation with a final violet pigment concentration of 3%.

Solution I: Into a 500 mL glass jar was placed 99.00 g of SR 238 (1,6 hexanediol diacrylate) and 10.00 g of SR339. To the solution was added 5.94 g of oil blue A (solvent blue 36) and 5.94 g of solvent violet 37 and the composition was mixed to disperse/dissolve the dyes. The mixture was centrifuges and the supernatant (193.85 g) was recovered. 0.68 g of Irgacure 819 and 3.30 g of TPO-L was added to the supernatant. The jar was then capped and placed in a shaker for mixing overnight. Most of the dye appeared to be dissolved in the acrylates. Subsequently, to the solution was added 90 of the base resin with photomer 6210. The solution was subjected to further mixing in a shaker for 1 hour. A homogeneous blue-colored solution was obtained.

### Examples 1-5

Microreplication was performed using a UV curing process as described in PCT Publication No. WO 9511464, and described above. Unless noted otherwise, the UV cure process used in these examples did not include the optional second radiation source described in FIG. 5.

Tool A, having a patterned area of approximately 7 inches by 36 inches, was secured to a mandrel having an approximate diameter of 37 inches using 3M 8402 adhesive tape. The Melinex 453 film was threaded from the unwind idler, along the surface of the Tool A, to the rewind idler as shown in FIG. 5. The surface-treated (adhesion-promoting) side of the film was facing the tool. The mandrel was heated to 54 C (130 F). The film was run at a line speed of 10 cm/s (20 feet per minute) at a nip pressure of 207 kPa (30 psi) at the contact point of the first nip roller (a 95 Shore D nitrile rubber roller) and the mandrel. Resin was applied to the film by manually pouring a small continuous bead of resin solution on the film at the hopper location upstream from the mandrel as depicted in FIG. 5. The resin spread laterally across the width of the tool at the rubber nip roller, forming a bank of solution approximately 9 inches wide. Resin solutions E, F, and G were used in Examples 1,2, and 3, respectively. Resins were cured using radiation from Fusion D lamps. The Fusion D lamps were operated at an input power of 236 watts per cm. The cured microwell array film article was removed from the tool at the second nip roller and wound on the rewind idler as shown in FIG. 5. Additional samples were made with the above procedure using Tool B instead of Tool A. Example 4 was made by using Tool B with resin solution F and Example 5 was made by using Tool B with resin solution H.

Cure depth for several examples were determined using a combination of SEM imaging and a thickness gauge and are shown in TABLE 1. It can be seen from these examples that increased photoinitiated cure depth can be accomplished by providing a tooling material that allows greater penetration of light (example 1 ) or alternatively adding a wavelength specific colorant with a lower absorbance cross section in the wavelength range of the photoinitiator (Example 5 ).

TABLE 1
Cure Depth

| | | | Microstructure |
|---|---|---|---|
| Example | | | Cure Depth |
| Number | Resin Solution | Tool | (microns) |
| 1 | F (3% carbon black) | A (urethane | 39 (full cure depth) |
| | | acrylate) | |
| 4 | F (2% carbon black) | B (polyimide) | about 12 |
| 5 | H (3% violet pigment) | B (polyimide) | 34 (full cure depth) |

Portions of selected samples were cut and dip coated using Scotchcast Electrical Resin #5. The samples were allowed to cure for at least 24 hours before microtoming.

The embedded samples were thin sectioned (10-um sections) using a diamond knife. The sections were placed in 1.515 RI oil and covered with a cover slip prior to imaging. Samples were imaged by optical microscopy. A number of sections (listed as “Count” in TABLE 2 ) were measured to determine the average thickness of the well base (bottom wall), as shown in TABLE 2.

TABLE 2
Thickness of material at the base of the wells in microns

| | Example 3 | Example 2 | Example 1 |
|---|---|---|---|
| | 1% carbon (G) | 2% carbon (F) | 3% carbon (E) |
| Average | 0.9 | 2.2 | 1.8 |
| Std. Dev. | 0.3 | 0.6 | 0.4 |
| CV | 0.31 | 0.27 | 0.22 |
| Minimum | 0.4 | 1.1 | 1.2 |
| Maximum | 1.4 | 3.5 | 3.0 |
| Count | 18 | 24 | 22 |

Approximately 1×1 inch samples were obtained from microstructured film examples 1-3 and Melinex 453 film. The films were placed on a 1×3 inch microscope slide, with a small gap (no film) between the samples. Brightfield transmission images were obtained using a Zeiss AxioPlan 2 microscope (Plan-Neofluor 10×/ 0.03 objective) and a Zeiss AxioPlan 2 digital camera (8 bit). Prior to final image acquisition the light intensity was adjusted to ensure the blank area between the films was below the saturation level of the digital camera. Line scans of each image were produced using ImagePro Plus image analysis software (Media Cybernetics) across the “blank” area of the slide (the gap between the films), an area of the slide that contained just the Melinex 453 film, and an area of the slide that contained the composite article comprising the colorant-containing resin cured on the Melinex 453 substrate. FIG. 6A is a drawing of a top view of one of the composite articles of Example 1, with the path of a linescan shown as dashed line A across the circular microwells and the area between the microwells. FIG. 6B (line 3) shows the pixel intensities of each pixel along the line scan shown in FIG. 6A. Also shown in FIG. 6B are the corresponding line scans for the “blank” (no film, line 1) and PET film (film only, line 2) images. Pixel intensities from the well bottoms were compared to the pixel intensities of the PET film to estimate the average percent transmission of light through the bottom walls of the wells. The calculated results are reported in TABLE 3. It can be observed from these measurements that the thin well base substantially transmits light while the walls are substantially non-transmissive.

TABLE 3
Light transmission through well base

| Example Number | % transmission |
|---|---|
| 3 (1% carbon black) | 86.9 |
| 2 (2% carbon black) | 87.9 |
| 1 (3% carbon black) | 80.2 |

Lateral light transmission through the sidewalls in the X-Y plane (see FIG. 1) of Example 1 was estimated by preparing a cured film of uniform thickness similar to the midpoint sidewall thickness in Example 1 (approximately 5 microns). A small amount of solution E was applied to a polyester film 1. This was covered with a second film 2 and manual pressure was applied to spread solution E between the films. The solution between the films was cured by passing under a UV source (500 W fusion lamp) at 7.6 cm/s (15 ft/min) with film 1 facing the UV source. Film 2 was removed and the resin adhered to film 1 on the UV-exposed side was washed to remove uncured monomer. Cured resin thickness was measured using a caliper gauge. The mean thickness was determined to be 4 microns. A portion of the film containing the cured resin was placed in a spectrophotomer (Tecan Infinite M200). Light transmission at 550 nanometers was measured at three locations. For the 4 micron film, a mean absorbance value of 1.4 was obtained, corresponding to a light transmission of 4%. This example serves to illustrate that the microstructured wells are substantially transmissive along the Z axis and substantially nontransmissive in the X-Y plane.

### Examples 6 and 7

Six micron thick Teonex Q71 film was primed on one side with a 5% solids solution of Vitel 1200B in an 85%/15% mixture of dioxolane and cyclohexanone via a slot-die coater, followed by drying in an oven at 160° F. for 2 minutes. The thickness of the coating was 300 nanometers as measured with a white light interferometer. The film was then coated on the opposite side with a silicone-polyurea adhesive which consisted of a 28% solids solution of an MQ resin (SR545) and a silicone polyurea (SPU) elastomer at a ratio of 55:45. The SPU elastomer was formed through the condensation reaction of a 33 kDa diamino terminated polydimethylsiloxane, Dytek A, and Desmodur W in a ratio of 1:1:2, as described in U.S. Pat. No. 6,824,820. The film was then dried in an oven at 160° F. for 2 minutes and laminated to a PET film by passing the material through a nip roll in contact with Loparex 10256 fluorosilicone treated PET release liner. The thickness of the coating was 4.2 microns as measured by a white light interferometer.

Example 6 was made by performing microreplication as in Examples 1-5 using the coated Teonex Q71 film in place of the Melinex 453 polyester film and by using Tool C and resin solution H. Example 7 was made as Example 6 except that resin solution I was used. In Examples 6 and 7 the Vitel 1200B-treated side of the Teonex Q71 film was positioned to face toward the replication tool.

Light transmission through the well base of the microstructure of Example 6 was measured as described for Examples 1-3 above. FIG. 7 shows the results of line scans through a “blank” portion of a slide (line 4), through the adhesive-coated PEN film (line 5), and through the microwell array article (line 6), respectively.

### Example 8

A sample made according to Example 1 was coated with a layer of silicon dioxide as follows to produce Examples 8. The silica deposition was done in a batch reactive ion plasma etcher (Plasmatherm, Model 3280). The microreplicated article was placed on the powered electrode and the chamber pumped down to a base pressure of 5 mTorr. The article was plasma treated first in an argon plasma at 25 mTorr pressure for 20 seconds. Following this, tetramethylsilane vapor was introduced at a flow rate of 150 sccm and plasma maintained at a power of 1000 watts for 10 seconds, following which, oxygen gas was added to the tetramethylsilane at a flow rate of 500 sccm with the power maintained at 1000 watts for another 10 seconds. After this step, the tetramethylsilane vapor flow rate was decreased in a stepwise manner from 150 sccm to 50 sccm, 25 sccm and 10 sccm while the plasma was still on and each of these steps lasted for 10 seconds. After the last step of tetramethylsilane vapor flow of 25 sccm, the flow was disabled and a 2 % mixture of silane gas in argon was introduced instead at a flow rate of 1000 sccm with the plasma maintained at 1000 watts and treatment performed for another 60 seconds. The plasma chamber was subsequently vented to atmosphere and the plasma treated microreplicated article was removed from the chamber.

### Examples 9 and 10

Microwell array articles were prepared by casting and curing solution E onto a 25 micron (1 mil) PET film as in Example 1. The PET side was exposed to a solution of potassium hydroxide (40 %) containing ethanolamine (20 %) to chemically etch the PET film. Etching was accomplished placing the microstructured side of a section of film (about 7.6 cm (3 inches) by 10 cm (4 inches)) against a sheet of printed circuit board material. The perimeter of the film was sealed against the board using 3M 8403 tape to prevent exposure of the solution to the structured side. The potassium hydroxide/ethanolamine solution was placed in a large glass container and heated to 80 C using a water bath. The boards with adhered films were immersed in the bath for a specified time followed by washing with water. Films etched for 3 minutes had 12 microns of remaining PET (Example 9). Films etched for 6 minutes and 10 seconds had 5 microns of PET remaining (Example 10).

### Examples 11-14

A silicone adhesive was coated onto a liner at various thicknesses. The adhesive consisted of a 28% solids solution of an MQ resin (SR545) and a silicone polyurea (SPU) elastomer at a ratio of 55:45. The SPU elastomer was formed through the condensation reaction of a 33 kDa diamino terminated polydimethylsiloxane, Dytek A, and Desmodur W in a ratio of 1:1:2, as in U.S. Pat. No. 6,824,820. The liner used was SilFlu 50MD07 which uses a fluorosilicone release chemistry on clear, 50 micron (2 mil) PET. The adhesive was coated using a knife coater with a 50 micron (2 mil) wet gap. The adhesive was diluted with toluene to achieve various thicknesses. The coated liner was dried in an oven at 115° C. for six minutes.

The adhesives were then laminated to samples of microwell array articles formed on PET film according to Examples 8, 15 and 16 using a rubber roller. The well structures were protected from damage with a PET film, which was then discarded. Example 11 was made by laminating 39 micron thick adhesive to the microwell array of Example 1, which had a PET film thickness of 25 microns, for a total base thickness of 64 microns. Example 12 was made by laminating 7 micron thick adhesive to the microstructure of Example 1, which had a PET film thickness of 25 microns, for a total base thickness of 32 microns. Example 13 was made by laminating 3 micron thick adhesive to the microstructure of Example 9, which had a PET film thickness of 12 microns, for a total base thickness of 25 microns. Example 14 was made by laminating 2 micron thick adhesive to the microstructure of Example 10, which had a PET film thickness of 5 microns, for a total base thickness of 7 microns.

To simulate an optical assay coupled to a detection device via a fiber optic face plate, light spread was measured as function of total base thickness below the microstructure (i.e., the base thickness included both the PET film plus the adhesive layer). After etching and application of adhesive, sections of films were applied to a fiber optic face plate (6 micron fiber diameters, 47A glass, Schott North America). Approximately 20 μl of aqueous solution containing approximately 1000 fluorescent beads (27 micron Fluorescebrite Plain Microspheres) was placed on the microstructured side of the laminated film. Beads were allowed to settle into the base of the microstructured wells by gravity. After the water was allowed to evaporate the laminated film/face plate assembly was placed in a fluorescence microscope (Zeiss AxioPlan 2 microscope, Plan-Neofluor 10×/0.03 objective, with fluorescein filter set) with the microstructure side facing down (away from the objective). The microscope was focused on the back side of the face plate. Images of the back side of the faceplate were acquired using a fluorescein filter set. The degree of light spread was approximated by counting the number of 6 micron fibers across the diameter of the fluorescent areas projected on the face plate. The results are shown in TABLE 4. It can be seen from this data that minimization of the base layer thickness decreases the amount of lateral light spread, which in turn minimizes optical cross talk between neighboring wells.

TABLE 4
Approximate projected diameter of 27 micron beads

| | Base Thickness | Number of 6 micron | Approximate Projected |
|---|---|---|---|
| | (PET + | fibers across | diameter of 27 micron |
| Example | adhesive) | diameter of pro- | bead on faceplate |
| Number | (microns) | jected bead image | (microns) |
| 11 | 64 | 11 | 66 |
| 12 | 32 | 8 | 48 |
| 13 | 15 | 6 | 36 |
| 14 | 7 | 5 | 30 |

### Example 15

A microstructured film was made and laminated to a silicone adhesive as described in Example 12 except that the thickness of the adhesive layer was about 12.5 microns (0.5 mils). Two 1″ wide strips of paper were laid on the surface of the microstructured film 70 mm apart. 2.06 mil Exco Film #29459 was placed on top of this entire construction and an iron was used to heat seal the film to the paper and microstructure. This film had good adhesion and made it very easy to handle the film without the adhesive liner.

### Example 16

A microstructured film was made and laminated to a silicone adhesive as described in Example 12 except that the thickness of the adhesive layer was about 12.5 microns (0.5 mils). Two 1″ wide strips of paper were laid on the surface of the microstructured film 70 mm apart. A 78#/3,000 ft² paper carrier (part number 402-7802) was placed on top of this entire construction and an iron was used to heat seal the film to the paper and microstructure. The paper carrier had poor adhesion to the microstructured film and did not hold the paper strips in place.

### Example 17

A microstructured film was made and laminated to a silicone adhesive as described in Example 12 except that the thickness of the adhesive layer was about 12.5 microns (0.5 mils). Two 1″ wide strips of paper were laid on the surface of the microstructured film 70 mm apart. Scotchpak 9733 was placed on top of this entire construction and an iron was used to heat seal the film to the paper and microstructure. The Scotchpak carrier had poor adhesion to the microstructured film and did not hold the paper strips in place.

### Example 18

A part was cut from the microassay device of Example 6 with approximate dimensions of 21 mm by 45 mm. CD-103 HDPE film was coated with the adhesive solution described in TABLE 5. The adhesive solution was applied to the HDPE film by gravure coating at a coating weight of 4.23 g/m².

TABLE 5

| | Wet Coating | Dry Coating |
|---|---|---|
| Component | (Wt. %) | (Wt. %) |
| WD-4007 Adhesive (HB Fuller) | 30.013 | 89.938 |
| WD-4008 Adhesive (HB Fuller) | 3.335 | 9.993 |
| Leucophor BCR Fluorescent Dye, | 0.023 | 0.069 |
| solids | | |
| Water, Total | 61.966 | 0 |
| Isopropyl Alcohol, Total | 4.663 | 0 |
| Total Solids (%) | 33.370 | 100.000 |

The microreplicated part was placed between two pieces of adhesive coated CD-103 HDPE films and laminated.

Upon opening of the package, the bottom liner of the microreplicated part stayed with one HDPE film, while the microreplicated part stayed adhered to the opposite HDPE film for positioning over a fiber optic faceplate.

The present invention has now been described with reference to several specific embodiments foreseen by the inventor for which enabling descriptions are available. Insubstantial modifications of the invention, including modifications not presently foreseen, may nonetheless constitute equivalents thereto. Thus, the scope of the present invention should not be limited by the details and structures described herein, but rather solely by the following claims, and equivalents thereto.

1. An article, comprising:
a flexible microassay device comprising an upper major surface that includes a plurality of microwells and a lower major surface, wherein an adhesive composition is bonded to at least a portion of the lower major surface;
a flexible first protective layer; and
a shielding element releasably coupled to the adhesive composition such that the shielding element is dimensioned to be substantially coextensive with the portion of the lower major surface that comprises the adhesive composition;
wherein the first protective layer is releasably coupled to the upper major surface of the microassay device.

2. An article according to claim 1, wherein the first protective layer is dimensioned to be substantially coextensive with the microassay device.

3. An article according to claim 1, wherein the adhesive composition forms an adhesive layer that is dimensioned to be substantially coextensive with the lower major surface of the microassay device

4. An article according to claim 1, further comprising a flexible second protective layer that is releasably coupled to the shielding layer and/or the first protective layer.

5. An article according to claim 4, wherein the second protective layer is dimensioned to be substantially coextensive with the lower major surface of the microassay device.

6. An article according to claim 1, wherein the first protective layer comprises a polymeric film.

7. An article according to claim 6, wherein the polymeric film is a translucent or an optically transparent polymeric film.

8. The article of claim 1, wherein the second protective layer comprises a polymeric film.

9. An article according to claim 8, wherein the polymeric film is a translucent or an optically transparent polymeric film.

10. An article according to claim 1, wherein the first protective layer comprises a first body region that is substantially coextensive with the microassay device, wherein the first protective layer further comprises a first tab region extending from the first body region.

11. An article according to claim 1, wherein the second protective layer comprises a second body region that is substantially coextensive with the microassay device, wherein the second protective layer further comprises a second tab region extending from the second body region.

12. An article according to claim 1, wherein at least a portion of each of the first and second tab regions overlap.

13. An article according to claim 1, further comprising a plurality of shielding elements.

14. An article according to claim 1, wherein at least one of the first and second protective layers is self-supporting.

15. An article according to claim 1, wherein the peel adhesion strength of the coupling between the first protective layer and the upper surface of the microassay device is greater than the peel adhesion strength of the coupling between the adhesive layer and the shielding element, wherein the peel adhesion strength of the coupling between the shielding element and the adhesive layer is less than the peel adhesion strength of the coupling between the shielding element and the second protective layer.

16. An article according to claim 1,
wherein the microassay device, the body region of the first protective layer, and the body region of the second protective layer each comprise a peripheral boundary; and
wherein the peripheral boundaries of the body regions of the first and second protective layers substantially extend outside peripheral boundary of the microassay device.

17. An article according to claim 16, wherein the peripheral boundaries of the body regions of the first and second protective layers substantially overlap to form a margin area.

18. An article according to claim 17, wherein a portion of the body region of first protective layer and the body region of the second protective layer are releasably coupled in the margin area.

19. An article according to claim 1, wherein the microassay device is fabricated from a polymeric resin selected from the group consisting of polyimide, polycarbonate, polystyrene, polypropylene, polyethylene, polybutylene, polyurethane, acrylic-based resins derived from epoxies, polyesters, polyethers, and urethanes, ethylenically unsaturated compounds, aminoplast derivatives having at least one pendant acrylate group, isocyanate derivatives having at least one pendant acrylate group, epoxy resins other than acrylated epoxies, derivatives of the foregoing, and combinations of two or more of the foregoing.

20. An article according to claim 1, wherein the first protective layer and/or second protective layer comprises a material selected from the group consisting of high density polyethylene, low density polyethylene, linear low density polyethylene, polyethylene terephthalate and Exco Film #29459 heat-sealable packaging film.

21. An article according to claim 1, wherein the first protective layer is coupled to the microassay device by a process selected from the group consisting of lamination and heat sealing.

22. An article according to claim 1, wherein the second protective layer is coupled to the shielding element by a process selected from the group consisting of lamination and heat sealing.

23. A method of making a carrier device, comprising:
providing,
a microassay device that includes upper and lower major surfaces, wherein the upper major surface comprises a plurality of microwells, wherein at least a portion of the lower major surface comprises an adhesive composition bonded thereto, wherein a shielding element is detachably attached to the adhesive composition and the shielding layer is substantially coextensive with the portion of the lower major surface that comprises the adhesive composition;
a first protective layer; and
detachably attaching the first protective layer to the upper major surface of the microassay device.

24. A method of making a carrier device, comprising:
providing,
a microassay device that includes upper and lower major surfaces, wherein the upper major surface comprises a plurality of microwells, wherein at least a portion of the lower major surface comprises an adhesive composition bonded thereto;
a shielding element;
a first protective layer;
detachably attaching the shielding element to the adhesive composition such that the shielding element is substantially coextensive with the portion of the lower major surface that comprises the adhesive composition; and
detachably attaching the first protective layer to the upper major surface of the microassay device.

25. The method of claim 23, further comprising the steps of providing a second protective layer and detachably attaching the second protective layer to the shielding element and/or the first protective layer.

26. A method of preparing a flexible microassay device for a microanalysis, comprising:
providing,
an article that includes,
a microassay device with upper and lower major surfaces, wherein the upper major surface includes a plurality of microwells, wherein the upper major surface is detachably attached to a first protective layer, wherein at least a portion of the lower major surface includes an adhesive composition bonded thereto;
a shielding element detachably attached to the adhesive composition such that the shielding element is substantially coextensive with the portion of the lower major surface that comprises the adhesive composition;
optionally, a second protective layer attached to the shielding element and/or the first protective layer;
a component of an optical system;
separating the shielding element from the microassay device; and
contacting the lower major surface of the microassay device with the optical system component.

27. The method of claim 26 further comprising removing the first protective layer from the microassay device.
